(19) United States
(12) Patent Application Publication
(10) Pub. No.: US 2004/0212714 A1
(43) Pub. Date: Oct. 28, 2004

(54) Digital camera

(75) Inventors: Hironobu Mikoshiba, Tokyo (JP); Haruki Nakayama, Osaka (JP)

Correspondence Address: MUSERLIAN AND LUCAS AND MERCANTI, LLP, 475 PARK AVENUE SOUTH, NEW YORK, NY, 10016, US

(73) Assignee: Konica Minolta Opto, Inc., Tokyo (JP)

(21) Appl. No.: 10/827,555

(22) Filed: Apr. 19, 2004

(30) Foreign Application Priority Data
Apr. 24, 2003 (JP) JP2003-120193

(51) Int. Cl. H04N 5/222

(52) U.S. Cl. 348/333.11

(57) ABSTRACT

A digital camera provided with an image pickup device; a readout controller for the electrical signals accumulated; a section to acquire image information according to the electrical signals readout; a controller for displaying images based on the image information; and a processor to output electrical signals accumulated in a first output area within an image capturing area at a first speed and to output electrical signals accumulated in the second output area at a second speed higher than the first speed; wherein the information of a predetermined area within the first output area is acquired during the signal output processing, and a moving image based on the image information of the predetermined area is displayed in a display area corresponding to the predetermined area during the signal output processing, and a still image is displayed in the other display area.

### BACKGROUND OF THE INVENTION

The present invention relates to a digital camera.

In recent years, there is known a digital camera in which an optical image of a photographic object focused through an optical lens is converted to electrical signals by an image pickup device such as a CCD and performed are monitor display and recording on a recording medium, of images based on image data comprising digital signals generated from said electrical signals.

Some of digital cameras are constituted so as to be able to perform signal output processing such as auto focus processing by which automatically adjusted is a focus at the time of image capturing of a photographic object, and some are also constituted so as to display a moving image on a monitor based on image data.

It is generally preferable to decrease a processing time for auto focus processing to be as short as possible with respect to preventing a user from missing the timing of image capturing of a photographic object. Therefore, there is known a digital camera constituted that, in auto focusing processing, each aligned row in a horizontal direction of a two dimensional image element arrangement constituting an image capturing area of an image pickup device is made to be one line, and a predetermined number of lines continuously arranged in a vertical direction is made to be an effective output area as well as a predetermined number of lines continuously adjacent to the effective output area is made to be a high-speed flush area (for example, refer to patent literature 1).

Specifically, in such a digital camera as described above, at the time of ordinary image capturing, that is, when a user is seeking for the timing of image capturing of a photographic object, a vertical synchronizing signal is output at a predetermined period so that electrical signals accumulated in all of the lines in an image capturing area are readout. While, at the time of auto focus processing, that is, when a user comes to a shutter chance to, for example, half-press a release switch, a digital camera outputs a vertical synchronizing signal at a period shorter than that of an ordinary image capturing to readout only effective electrical signals accumulated in an effective output area within all the lines in an image capturing area, as well as flushes unnecessary electrical signals accumulated in a high-speed flush area at a high speed.

Thus, at the time of auto focus processing, a rate of readout of electrical signals can be made faster, by the portion of a high-speed flush area, compared to the case that electrical signals of all the lines are readout at ordinary image capturing, which results in decrease of the time for acquiring image data to shorten time for said auto focus processing.

Patent literature 1: JP-A No. 2000-13686 (Hereinafter, JP-A refers to Japanese Patent Publication Open to Public Inspection)

### Problems to be Solved

Herein, in the case of such as aforesaid patent literature 1, when a monitor image is displayed depending on image data acquired based on electrical signals being output from an effective output area during signal output processing such as auto focus processing, since the aforesaid image data lacks the information corresponding to the image data of a high-speed flush area, an image lacking the image corresponding to image data in a high-speed flush area is displayed on a monitor (refer to FIG. 8). That is, in signal output process, since an image lacking the image corresponding to the image data of a high-speed flush area is displayed on a monitor, a user may have an impression that a lack of image data is caused during signal output processing, which results in deterioration of the product value. Therefore, it has been difficult to provide a digital camera with a signal output processing function to make said digital camera to be satisfactory convenient for a user.

An objective of this invention is to relax an impression for a user that a lack of image information is caused during signal output processing, and thereby to provide a digital camera which is satisfactorily convenient for a user.

### SUMMARY OF THE INVENTION

The above problems can be solved by the following constitutions.

(1) A digital provided with an image pickup device having an image capturing area for converting optical images of a photographic object into electrical signals to accumulate; a readout controller to control readout of the electrical signals accumulated in the image capturing area of the image pickup device; an image information acquiring section to acquire image information according to the electrical signals being readout under the control of the readout controller; an image display controller for controlling a display section to display images based on the image information having been acquired by the image information acquiring section; and a signal output process executing section for executing signal output processing to output electrical signals accumulated in a first output area within the image capturing area of the image pickup device at a first speed as well as to output electrical signals accumulated in the second output area other than the first output area at a second speed higher than the first speed; wherein the image information acquiring section acquires image information of a predetermined area according to electrical signals of the predetermined area within the first output area having been output by the signal output process executing section during the signal output processing, and the image display controller controls to display a moving image based on the image information of the predetermined area acquired by the image information acquiring section in a display area corresponding to the predetermined area within a display area of the display section during the signal output processing, as well as displaying a predetermined still image in the display area other than the display area corresponding to the predetermined area in the display section.

According to the constitution of item (1), since an image based on predetermined area image information by an image display controller is displayed as a moving image in a display area corresponding to a predetermined area within a display area of a display section as well as a predetermined still image is displayed in a display area other than the display area corresponding to a predetermined area of a display section to result in displaying an image in the whole of the display area of a display section, it is possible to make a user recognize that signal output processing is in progress by a moving image displayed in the display area corresponding to a predetermined area within a display area of a display section as well as to be able to relax the impression of a user that an image displayed in a display section is an image based on image information lacking a part of the information. Thereby, it is possible to provide a digital camera being satisfactory convenient for a user.

### BRIEF DESCRIPTION OF THE DRAWINGS

FIG. 1 is a block diagram to show a primary constitution of a digital camera of the first embodiment according to this invention.

FIGS. 2(a) and 2(b) are drawings to explain readout of electrical signals at the time of ordinary image capturing by a digital camera of FIG. 1.

FIGS. 3(a) and 3(b) are drawings to explain readout of electrical signals at the time of auto focus processing by a digital camera of FIG. 1.

FIG. 4 is a flow chart to show an example of movement related to image capturing process by a digital camera of FIG. 1.

FIGS. 5(a) and 5(b) are drawings to show display examples of an image being displayed on a monitor during image capturing process by a digital camera of FIG. 1.

FIG. 6 is a drawing to show a display example of an image being displayed on a monitor during image capturing process by a modified example of a digital camera.

FIG. 7 is a drawing to show a display example of an image being displayed on a monitor during image capturing process by the second embodiment of a digital camera according to this invention.

FIG. 8 is a drawing to show a display example of an image being displayed on a monitor during auto focus processing in a conventional digital camera.

### DETAILED DESCRIPTION OF THE PREFERRED EMBODIMENT

In the following, described will be other constitutions to solve the aforesaid problems.

(2) The digital camera described in item (1), wherein the aforesaid still image is a predetermined color image.

According to item (2), effects similar to those of the constitution described in item (1) can be naturally achieved, in addition, specifically, since a still image is a predetermined color image resulting in displaying an image based on image information of a predetermined area as a moving image in the background of a still image comprising a color image in a display area of a display section, it is possible to make a user more appropriately recognize that signal output processing is in progress.

(3) The digital camera described in item (1), wherein the aforesaid image information acquiring section acquires the whole display area image information corresponding to the whole display area of the aforesaid display section based on the electrical signals being readout under the control of the aforesaid readout controller at the starting timing of the aforesaid signal output processing, and the aforesaid image display controller controls displaying an image as the aforesaid still image on said display section during said signal output processing based on image information, in which the aforesaid predetermined area image information having been removed from said whole display area image information, being acquired by said image information acquiring means.

According to item (3), effects similar to those of the constitution described in item (1) can be naturally achieved, in addition, specifically, since an image display controller controls displaying an image as a still image on a display section during signal output processing based on image information, in which predetermined area image information having been removed from whole display area image information, being acquired by an image information acquiring section, an image being displayed in a display area of a display section as a moving image based on predetermined area image information in the background of a still image comprising an image based on image information in which predetermined area image information having been removed from of whole display area image information, which results in making a user more appropriately recognize that signal output processing is in progress.

(4) A digital camera equipped with an image pickup device to accumulate an optical image of a photographic object by converting it into electrical signals, a readout controller to control readout of electrical signals accumulated in an image capturing area of said image pickup device, an image information acquiring means to acquire image information according to said electrical signals being readout under the control of the aforesaid readout controller, and an image display controller to control image display based on said image information acquired from said image information acquiring means; wherein provided is a signal output process executing section to execute signal output processing to output effective electrical signals accumulated in the first output area within said image capturing area of said image pickup device as well as to output unnecessary electrical signals accumulated in the second output area other than said first output area at a high speed, said image information acquiring means acquires whole display area image information corresponding to the whole display area of said display section based on said electrical signals having been readout under control of said readout controller at the starting timing of said signal output processing by means of said signal output process executing section, and said image display controller controls displaying a still image based on of the whole display area image information having been acquired by means of said image information acquiring section.

According to item (4), since an image display controller controls to display a still image based on the whole display area image information in the whole display area of a display section resulting in an image being displayed on the whole display area of an image display section, it is possible to make a user recognize that a signal output processing is in progress as well as to relax an impression of a user that a lack of an image information is caused during signal output processing. Thereby, provided can be a digital camera being satisfactory convenient for a user.

(5) A digital camera described in anyone of items (1) to (4), wherein the digital camera is further provided with an auto focus processing section for executing an auto focus processing to adjust a focus automatically at the time of image capturing of a photographic object, wherein when the auto focus processing is executed, the signal output process executing section executes the signal output processing to output the electrical signals accumulated in the first output area within the image capturing area of the image pickup device at the first speed as well as to output the electrical signals accumulated in the second output area other than the first output area at the second speed.

According to item (5), an auto focus processing section for executing an auto focus processing to adjust a focus automatically at the time of image capturing of a photographic object is further provided, and effects similar to those of constitutions described in items (1) to (4) can be achieved also in this case.

(6) The digital camera described in anyone of items (1) to (4), further provided with an auto focus processing section for executing an auto focus processing to adjust a focus automatically at the time of image capturing of a photographic object, wherein when the auto focus processing is executed, the signal output process executing section executes the signal output processing to output the electrical signals accumulated in the first output area within the image capturing area of the image pickup device at the first speed as well as to output the electrical signals accumulated in the second output area other than the first output area at the second speed,

wherein a predetermined area within the first output area includes a focus adjusting area where a focus adjusting position of the photographic object exists.

According to item (6), naturally achieved can be effects similar to those of the constitutions described in items (1) to (3), in addition, specifically, since an auto focus processing section for executing an auto focus processing to adjust a focus automatically at the time of image capturing of a photographic object is further provided, and the focus adjusting area where a determining focused position of a photographic object presents is included in a predetermined area within the first output area, it is possible to make a user appropriately recognize a determining focused position of auto focus processing by a moving image displayed in a display area corresponding to a predetermined area within a display area of a display section.

(7) The digital camera described in item (3), further provided with an auto focus processing section for executing an auto focus processing to adjust a focus automatically at the time of image capturing of a photographic object, wherein when the auto focus processing is executed, wherein the signal output process executing section executes the signal output processing to output the electrical signals accumulated in the first output area within the image capturing area of the image pickup device at the first speed as well as to output the electrical signals accumulated in the second output area other than the first output area at the second speed, a focus adjusting area where a determining focused position of said photographic object exists is included in a predetermined area within the aforesaid first output area, the aforesaid image information acquiring section acquires image information of a focus adjusting area based on the aforesaid electrical signals of said focus adjusting area within said first output area having been output by the aforesaid signal output process executing section during said auto focus processing, and the aforesaid image display information controller controls to display an image based on image information in which the aforesaid focus adjusting area image information acquired by said image information acquiring section having been removed from the aforesaid the whole display area image information.

According to item (7), naturally obtained can be effects similar to those of the constitution described in item (3), in addition, specifically, an image display controller controls to display an image based on image information in which image information of a focus adjusting area acquired by image information acquiring section from whole display area image information. That is, a moving image based on image information of a focus adjusting area is displayed in the background of a still image based on image information in which focus adjusting area image information having been erased from whole display area image information in a display area of a display section during auto focus processing, which results in making a user more appropriately recognize a determining focused position during an auto focus processing.

(8) A method for controlling a digital camera provided with an image pickup device having an image capturing area for converting optical images of a photographic object into electrical signals to accumulate and with a display for displaying images based on image information, the method including the steps of: reading out of the electrical signals accumulated in the image capturing area of the image pickup device; acquiring image information according to the electrical signals; displaying images based on the image information having been acquired; and executing signal output processing to output electrical signals accumulated in a first output area within the image capturing area of the image pickup device at a first speed as well as to output electrical signals accumulated in the second output area other than the first output area at a second speed higher than the first speed; acquiring image information of a predetermined area according to electrical signals of the predetermined area within the first output area during the signal output processing; and displaying a moving image based on the image information of the predetermined area in a display area corresponding to the predetermined area within a display area of the display section during the signal output processing, as well as displaying a predetermined still image in the display area other than the display area corresponding to the predetermined area in the display section.

### EMBODIMENTS OF THE INVENTION

### The First Embodiment

In the following, a specific embodiment according to the present invention will be explained in reference to drawings, however, the scope of the invention is not limited thereto.

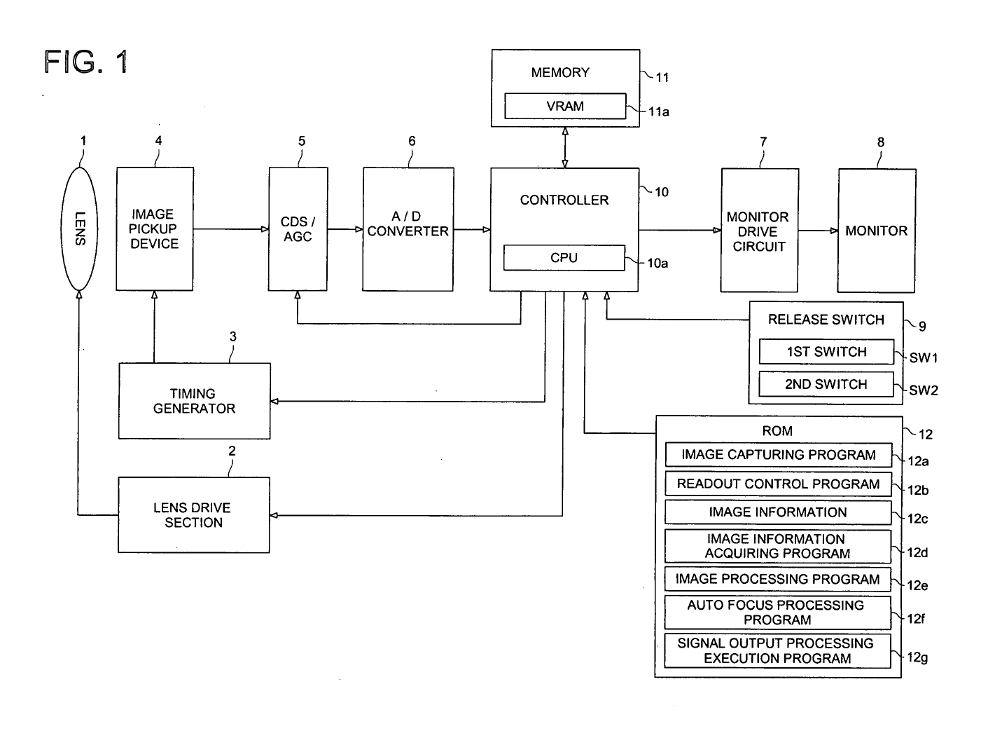

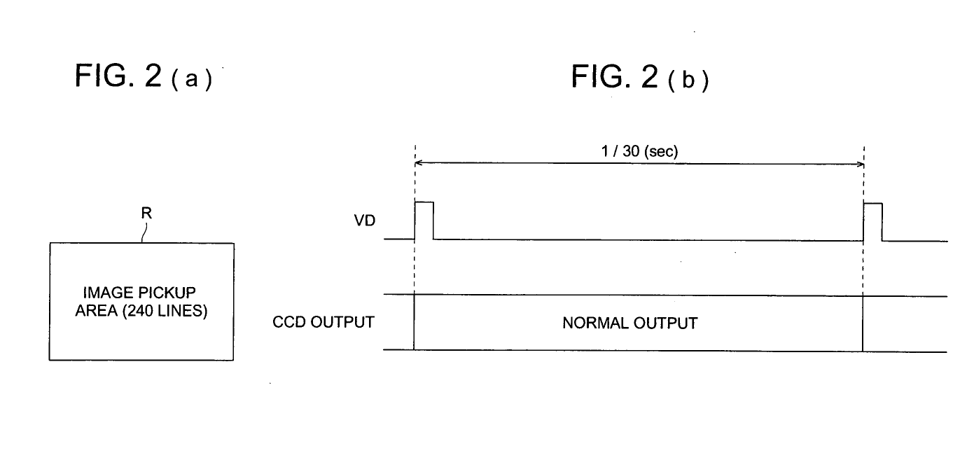

FIG. 1 is a block diagram to show the primary constitution of a digital camera exemplified as the first embodiment according to this invention. Further, FIG. 2 is a drawing to explain readout of electrical signals at the time of ordinary image capturing by a digital camera, FIG. 2(a) of which is a drawing to schematically show an image capturing area of an image pickup device and FIG. 2(b) of which is a time chart to show a readout operation of electrical signals accumulated in the image pickup device of FIG. 2(a).

According to the method of item (1), since an image based on predetermined area image information by an image display controller is displayed as a moving image in a display area corresponding to a predetermined area within a display area of a display section as well as a predetermined still image is displayed in a display area other than the display area corresponding to a predetermined area of a display section to result in displaying an image in the whole of the display area of a display section, it is possible to make a user recognize that signal output processing is in progress by a moving image displayed in the display area corresponding to a predetermined area within a display area of a display section as well as to be able to relax the impression of a user that an image displayed in a display section is an image based on image information lacking a part of the information. Thereby, it is possible to provide a method for controlling a digital camera, which being satisfactory convenient for a user.

As is shown in FIG. 1, digital camera 100 is constituted by being equipped with such as lens 1, lens drive section 2, timing generator 3, image pickup device 4, CDS/AGC 5, A/D converter 6, monitor drive circuit 7, monitor 8, release switch 9, controller 10, memory 11 and ROM 12.

Lens 1 is a part to focus an optical image of a photographic object on the optical path, and, for example, is constituted of a plural of lenses (being not shown in the drawing) to capture an optical image of a photographic object.

Lens drive section 2 is constituted by being equipped with, for example, a lens drive circuit and a lens drive motor (both being not shown in the drawing), and a lens drive circuit outputs a motor drive signal into a lens drive motor according to a lens drive indication being output and input from controller 10, then a lens drive motor rotatively drives based on a motor drive signal to transport a lens along an optical axis direction.

In this manner, a determining focused position of lens 1 is adjusted.

Image pickup device 4 is constituted of, for example, such as a sensor successively flushing electrical signals accumulated in such as CCD (charge Coupled Device) at a predetermined timing.

Further, image pickup device 4 is constituted by being provided with an image capturing area, comprising a plural number of image elements to convert an optical image of a photographing object into electrical signals (analogue signals) to be accumulated on the photoreceptor planeside. A plural number of image elements constituting the image capturing area are arranged two dimensionally in horizontal and vertical directions, and, each row of elements in the horizontal direction of image elements being defined as one line, electrical signals accumulated in all the image elements are readout at a predetermined frequency by successively scanning all the lines synchronously with vertical synchronizing signal VD (refer to FIG. 2), which are output into CDS/AGC 5.

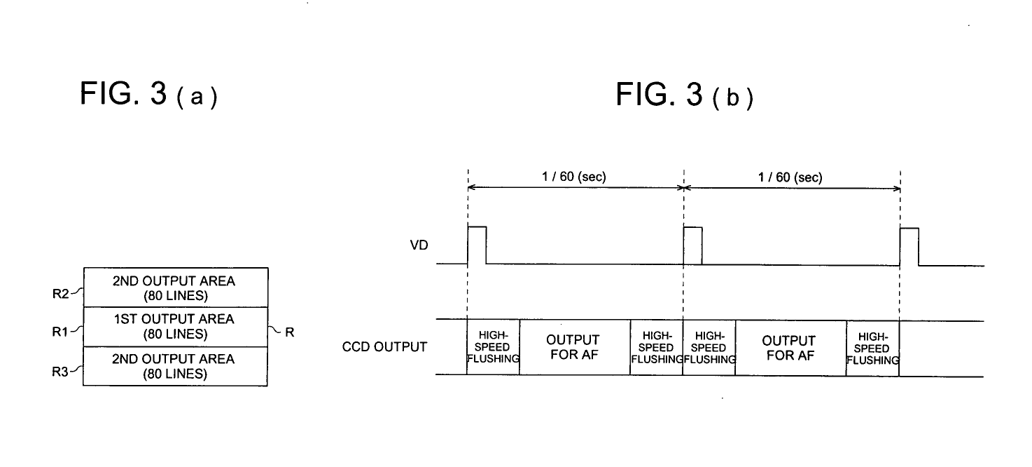

Herein, in image pickup device 4 when the signal output processing described below is performed, a predetermined number in a vertical direction continuously arranged at nearly the center, for example, 80 lines are defined as first output area R1 capable of outputting effective electrical signals, and each predetermined number of lines continuously arranged before and after first output area R1, for example, 80 lines are defined as second output areas R2, R3 capable of outputting unnecessary electrical signals at a high speed (refer to FIG. 3(a)).

Further, for example, a predetermined area at nearly the center within first output area R1 is a focus adjusting area where a determining focused position of a photographic object presents (being not shown in the drawing).

Vertical synchronizing signal VD is constituted to be generated synchronously with a timing signal being output from timing generator 3.

Timing generator 3 is constituted so as to generate a predetermined pulse signal, such as the aforesaid timing signal, with respect to drive of image pickup device 4 according to indications from controller 10 and to output the generated pulse signal into image pickup device 4.

CDS (Correlated Double Sampling)/AGC (Automatic Gain Controller) 5 removes such as reset noise from electrical signals being output and input from image pickup element 4 according to indications of controller 10, and outputs the signals into A/D converter 6 after amplification and/or adjustment.

A/D converter 6 outputs electrical signals being output and input from CDS/AGC 5 into controller 10 after converting them into digital signals.

ROM (Read Only Memory) 12 is a programmable semiconductor memory, and memorizes various application programs with respect to various functions of digital camera 100 being executed by controller 10. Specifically, ROM 12 memorizes such as image capturing program 12a, readout control program 12b, image information acquiring program 12c, image processing program 12d, image display control program 12e, auto focus processing program 12f and signal output processing execution program 12g.

Memory 11 is constituted of, for example, a volatile semiconductor memory, and provided with a working area to store such as various application programs, data and parameters which can be readout from ROM 12 to be executed in digital camera 100 under the control of controller 10.

Further, memory 11 is constituted by being equipped with VRAM (Video Random Access Memory) 11a to temporarily store image data for being displayed on monitor 8 according to display indications from controller 10.

Controller 10 is constituted by being equipped with CPU (Central Processing Unit) 10a, and this CPU 10a readouts various application programs with respect to various functions of digital camera 100 memorized in ROM 12 and develops them in a working area of memory 11 to execute various processes according to said programs. Then, CPU 10a stores the processed results in a predetermined area of memory 11 as well as displays them on monitor 8.

CPU 10a, specifically, readouts image capturing program 12a memorized in ROM 12 and develops it in memory 11, to execute image capturing process according to this image capturing program.

In this image capturing process, CPU 10a executes readout of electrical signals accumulated in image capturing area R of image pickup device 4 at a predetermined frequency, by controlling such as timing generator 3 according to readout control program 12b as a readout controller. Specifically, CPU 10a, as is shown, for example, in FIGS. 2(a) and 2(b), outputs vertical synchronizing signal VD at a 1/30 second period at the time of ordinary image capturing, that is, for example, when a user is seeking for an image capturing timing of a photographic object, and make electrical signals accumulated in all the lines, for example 240 lines, in image capturing area R of image pickup device 4, to be readout.

Further, CPU 10a, as an image information acquiring means, acquires image data based on electrical signals having been converted from analogue signals into digital signals, by controlling such as CDS/AGC 5 according to image information acquiring program 12c. At this time, CPU 10a, as an image processing means, provides acquired image data with image processing such as color processing, condensation processing corresponding to a storing mode of a recording medium and conversion processing corresponding to a display mode capable of being displayed on monitor 8, according to image processing program 12d.

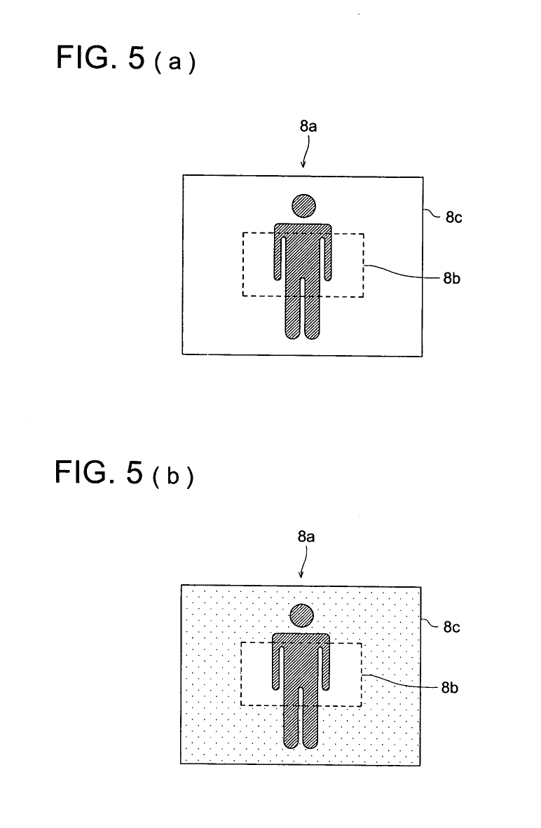

Further, CPU 10a, as an image display controller, preview displays an image based on image data, having been subjected to image processing, on monitor 8 at a predetermined frame rate, for example, at 30 fps (frames per second) by controlling monitor drive circuit 7 according to image display control program 12e (refer to FIG. 5(a)).

Further, in image capturing process of this embodiment, CPU 10a is constituted so as to be able to execute auto focus processing to automatically adjust a focus of a photographic object.

In the following, auto focus processing will be explained in reference to FIG. 3.

Herein, FIG. 3 is a drawing to explain readout of electrical signals at the time of auto focus processing of digital camera 100, and FIG. 3(a) of which is a schematic drawing to show image capturing area R of image pickup device 4, and FIG. 3(b) of which is a time chart to show readout and flushing operations of electrical signals accumulated in image pickup device 4.

That is, CPU 10a, when an operation signal being output based on a half-pressed operation of release switch 9 by a user, readouts auto focus processing program 12f from ROM 12 to be developed on memory 11, and executes auto focus processing according to this auto focus processing program 12f.

In this auto focus processing, specifically, CPU 10a, for example, acquires image data by image capturing of a photographic object while transporting a lens from the nearest image capturing position to the farthest image capturing position by driving lens drive section 2, and stored successively in memory 11 are the frequency analysis data acquired by performing a specific frequency analysis at a plural number of focus adjusting positions with respect to the acquired image data. Then CPU 10a defines the image capturing position having the best evaluation value as a determining focused position, by evaluating a determining focused state of an optical image of a photographic object at focus adjusting positions of said image data based on the frequency analysis data having been stored in memory 11.

Further, CPU 10a, as a signal output processing execution means in auto focus processing, executes signal output processing to output effective electrical signals accumulated in first output area R1 of image pickup device 4 at a predetermined frequency as well as to flush (output) unnecessary electrical signals accumulated in second output areas R2 and R3 at a frequency higher than that of first output area R1 by controlling such as timing generator 3 according to signal output processing execution program 12g.

Specifically, CPU 10a, for example, as is shown in FIGS. 3(a) and 3(b), outputs vertical synchronizing signal VD at a 1/60 second period to readout only 80 lines of effective electrical signals accumulated in first output area R1 out of 240 lines of image capturing area R, while flushes each 80 lines of unnecessary electrical signals accumulated in second output areas R2 and R3.

Then, during signal output processing, CPU 10a as an image information acquiring means acquires focus adjusting area image data (predetermined area image information) based on electrical signals being output from image pickup device 4 in a focus adjusting area within first output area R1. Further, during signal output processing, CPU 10a controls to display an image (refer to FIG. 5(b)) based on focus adjusting area image data acquired in display area 8b corresponding to a focus adjusting area within display area 8a of monitor 8 as a moving image at a predetermined frame rate, for example at 60 fps as well as to display a predetermined still image (refer to FIG. 5(b)) in display area 8c other than display area 8b corresponding to a focus adjusting area of monitor 8.

Herein, the aforesaid still image is, for example, an image based on the image data which has been acquired by CPU 10a as an image information acquiring means based on electrical signals having been readout from image pickup device 4 at a starting timing of auto focus processing and generated by further having been subjected to erasing of focus adjusting area image data from whole display area image data corresponding to whole display area 8a in monitor 8.

Monitor drive circuit 7 drives monitor 8 to display a predetermined image corresponding to digital image data having been output and input from controller 10. Further, monitor drive circuit 7 is constituted so as to display such as an operation image plane according to operation image plane data necessary for each image capturing mode or various setups.

Monitor 8 (display section) is constituted of such as a LCD (Liquid Crystal Display) and an EL (Electro-Luminescence) display.

Release switch 9 is a two-step switch provided with first switch SW1 for focusing and second switch SW2 for shuttering.

First switch SW1 works by an operation of a user to make release switch 9 half-pressed, and is capable of outputting an operation signal to start auto focus processing into controller 10.

Second switch SW2 works by an operation of a user to make release switch 9 full-pressed, and is capable of outputting an operation signal to record image data captured by image pickup device 4 on a recording medium into controller 10.

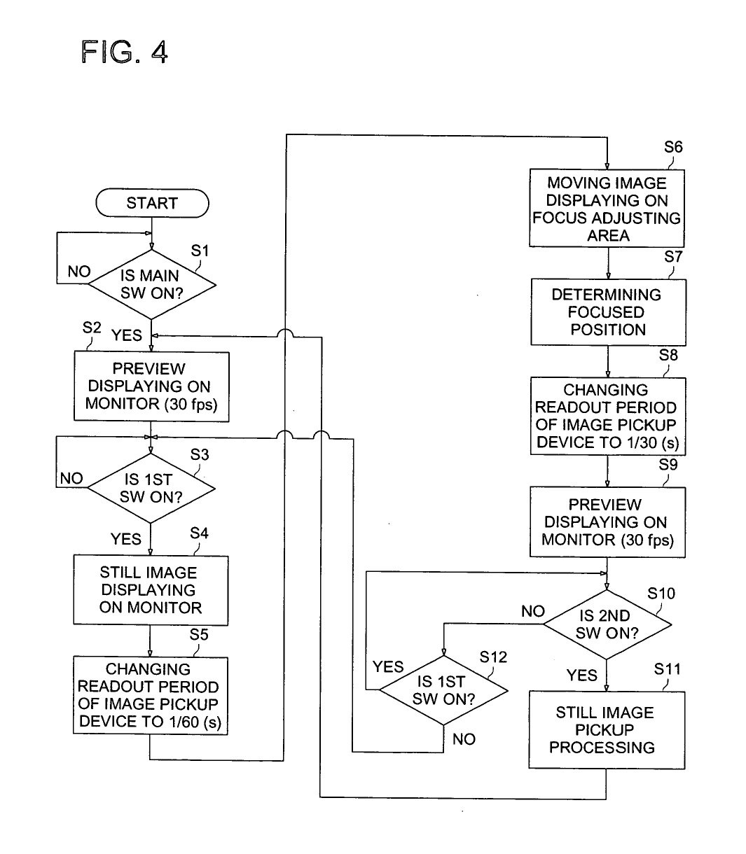

Next, an image capturing process by digital camera 100 will be explained in reference to FIG. 4.

Herein, FIG. 4 is a drawing to show an example of operation with respect to an image capturing process by digital camera 100, and FIG. 5 is a drawing to show an exemplary image displayed on monitor 8 during image capturing process by digital camera 100.

First, as is shown in FIG. 4, by being operated the main switch of digital camera 100 by a user to make the power source of said digital camera 100 ON (step S1; Yes), CPU 10a executes image capturing program 12a to control such as timing generator 3, CDS/AGC 5 and memory 11 resulting in acquiring image data of a photographic object, which has been condensed through lens 1 and focused on image pickup device 4, at a 1/30 second period. This image data is successively output into VRAM 11a to be temporally stored therein.

Then, CPU 10a preview displays an image based on the image data on monitor 8, for example, at 30 fps, by successive readout of the image data having been stored in VRAM 11a as well as by control of monitor drive circuit 7 (step S2). Specifically, for example, such an image as shown in FIG. 5(a) is displayed on whole display area 8a of monitor 8.

Next, CPU 10a executes a judgment program (being not shown in the drawing) to judge whether first switch SW1 is ON or not based on an operation signal being output by half-pressed operation of release switch 9 by a user (step S3).

Herein, CPU 10a, when it judges that first switch SW1 is operated (step S3; Yes), readouts auto focus processing program 12f from ROM 12 and develops it in memory 11, and controls execution of auto focus processing according to this auto focus processing program 12f. While, CPU 10a, when it judges that first switch SW1 is not operated (step S3; No), keeps the state of displaying an image during image capturing on monitor 8 resulting in a waiting state of operation of first switch SW1.

In auto focus processing, first, CPU 10a readouts image information acquiring program 12c from ROM 12 and develops it in memory 11, and acquires whole display area image data corresponding to whole display area 8a of monitor 8 at a timing of first switch SW1 is operated, that is, at a starting timing of auto focus processing according to this image information acquiring program, then displays an image as a still image based on said whole display area image data (step S4).

Next, CPU 10a readouts output signal processing execution program 12g from ROM 12 and develops it in memory 11, and converts the readout period of electrical signals accumulated in each image element of image pickup device 4 to 1/60 second by controlling timing generator 3 according to this output signal processing execution program 12g (step S5), thereby outputs vertical synchronizing signal VD at a 1/60 period to perform signal output processing to readout only effective electrical signals having been accumulated in, for example, 80 lines of first output area R1 within, for example, 240 lines of an image capturing area of image pickup device 4, while to flush unnecessary electrical signals accumulated in, for example, each 80 lines of second output areas R2 and R3 at a high speed.

Next, CPU 10a readouts image information acquiring program 12c from ROM 12 and develops it in memory 11, and acquires focus adjusting area image data based on electrical signals in a focus adjusting area within first output area R1 during signal output processing according to this image information acquiring program 12c. This focus adjusting area image data is successively output into VRAM 11a and is temporally stored in said VRAM 11a.

Then, CPU 10a generates image data after erasure in which focus adjusting area image data has been erased from the whole display area data.

Successively, CPU 10a readouts image display control program 12e from ROM 12 and develops it in memory 11, and successively readouts the image data having been stored in VRAM 11a and displays an image as a moving image, for example, at 60 fps, in display area 8b corresponding to a focus adjusting area within display area 8a of monitor 8 as well as displays an image based on the image data after erasure as a still image in display area 8c other than display area corresponding to a focus adjusting area in monitor 8, during signal output processing according to this image display control program 12e (step S6).

Next, CPU 10a, during signal output processing, while performing image display such as described above on monitor 8, decides a determining focused position based on specific frequency analysis of focus adjusting area image data acquired according to image information acquiring program 12c at a plural number of focus adjusting positions (step S7).

Next, CPU 10a once stops storing (renewing) of focus adjusting area image data in VRAM 11a, and displays an image based on the focus adjusting area image data at this stop timing as a still image in display area 8b corresponding to a focus adjusting area within display area 8a of monitor 8. Therefore, this is a state that a still image is displayed in whole display area 8a of monitor 8.

Successively, CPU 10a changes the period of readout electrical signals accumulated in each image element of image pickup device 4 into 1/30 second (step S8) and acquires image data at this period. This image data is successively output into VRAM 11a and is temporarily stored in this VRAM 11a.

Then, CPU 10a successively readouts image data having been stored in VRAM 11a, and preview displays an image based on the image data, for example, at 30 fps on monitor 8 (step S9).

Next, CPU 10a, by executing a judgment program (being not shown in the drawing) judges whether second switch SW2 is on or not based on an operation signal being output by full-press operation of release switch 9 by a user (step S10).

Herein, CPU 10a, in the case that it judges second switch SW2 being pressed (step S10; Yes), executes a still image capturing process to record image data on a predetermined recording medium based on an operation signal having been output and input by said operation of second switch SW2 (step S11).

Wherein, after still image capturing process, CPU 10a moves to step S2 and successively executes the following processes.

Further, in step S10, CPU 10a, in the case of judging that second switch SW2 is not pressed (step S10; No), judges whether first switch SW1 is operated or not (step S12). Herein, CPU 10a moves to step S10 when it judges that first switch SW1 is operated (step S12; Yes), while moves to step S3 when it judges that first switch SW1 is not operated (step S12; No).

As described above, according digital camera 100 of this embodiment, in auto focus processing, since an image is displayed on whole of display area 8a of monitor 8, it is possible to make a user recognize that signal output processing is in progress during auto focus processing by a moving image displayed in focus adjusting area 8b within display area 8a of monitor 8 as well as to relax the impression of a user that images displayed on a monitor is an image based on image data lacking a part of the information. Thereby, it is possible to provide digital camera 100 exhibiting an excellent convenience for a user.

Further, during signal output processing, since an image based on focus adjusting area image data as a moving image is displayed in the background of a still image comprising an image based on image data in which focus adjusting area image data was erased from whole display area image data, in display area 8a of monitor 8, it is possible to make a user furthermore appropriately recognize that signal output processing is in progress as well as to make a user appropriately recognize a determining focused position in auto focus processing.

Further, at the timing to change a frame rate of an image displayed on monitor 8 (such as step S4), since a predetermined image is displayed as a still image on said monitor 8, change of a frame rate can be performed smoothly and the impression of a user that a frame rate has been changed can be relaxed, which results in providing a user with digital camera 100 exhibiting furthermore excellent convenience.

<Modified Example>

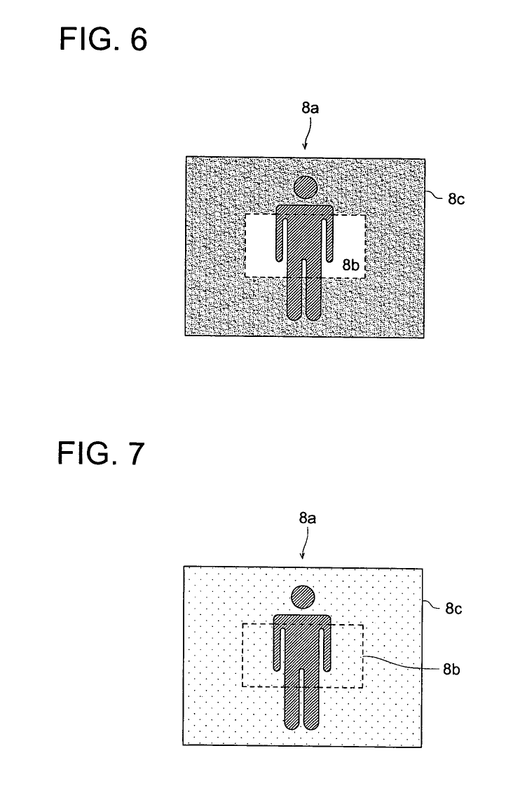

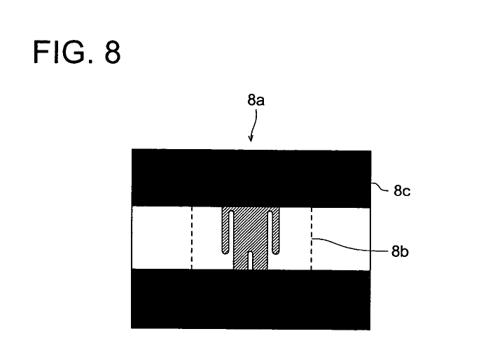

The digital camera of this modified example, as is shown in FIG. 6, is constituted so as to display a predetermined monochrome image as a still image in display area 8c other than display area 8b corresponding to a focus adjusting area of monitor 8, during signal output processing. That is, on monitor 8, an image based on focus adjusting area image data is displayed as a moving image in the background of a predetermined monochrome image.

Herein, image data of a still image is stored, for example, in ROM 12, although which is not shown in the drawing.

Therefore, according to the digital camera of this modified example, it is naturally possible to achieve effects similar to those in digital camera 100 of the first embodiment described above, as well as to make a user furthermore appropriately recognize that signal output processing is in progress.

In addition, in the above modified example, color of a still image may be any color, however, is preferably such a color which makes an image based on focus adjusting area image data distinct in the background of said still image. Specifically, for example, a still image is preferably comprised of darker colors when an object in a bright place is photographed, while a still image is preferably comprised of brighter colors when an object in a dark place is photographed; thereby, an image based on focus adjusting area image data can be displayed more appropriately.

Further, in the above modified example, a still image is constituted of a monochrome image, however, it is not limited thereto, and may be also constituted of plural colors. In this case, a still image may be constituted of a predetermined pattern.

Further, image data of a still image may be recorded as a default at the time of shipment of the product in advance, and may be those designed depending on individual favorite of a user.

In addition to this, image data of a still image may naturally be acquired by said digital camera 100 via a certain communication means of either wired or wireless.

Herein, in the modified example of the above embodiment, exemplified is a constitution in which a predetermined area in first output area R1 is a focus adjusting area, however, it is not limited thereto, and acceptable provided that a focus adjusting area is at least included in a predetermined area within first output area R1.

Further, in the modified example of the above embodiment, also possible is a constitution in which an image based on focus adjusting area image data is displayed with enlargement on whole display area 8a of monitor 8, during signal output processing.

### Second Embodiment

In the following, a digital camera of the second embodiment according to this invention will be explained in reference to FIG. 7.

Herein, FIG. 7 is a drawing to show an exemplary image displayed on monitor 8 during image capturing process by a digital camera of the second embodiment according to this invention.

A digital camera of the second embodiment, as is shown in FIG. 7, is constituted so as to display a still image in whole display area 8a of monitor 8 based on image data corresponding to whole display area 8a of monitor 8 which has been acquired at the timing of first switch SW1 is operated, that is, at the start timing of auto focus processing, during signal output processing.

That is, CPU 10a as an image information acquiring means, acquires image data based on electrical signals having been readout from image pickup device 4 at the start timing of auto focus processing, and also as an image display controller, controls to display a still image based on whole display area image data in whole display area 8a of monitor 8, during signal output processing.

Therefore, according to a digital camera of this embodiment, in auto focus processing, since an image is displayed in whole of display area 8a of monitor 8, it is possible to make a user recognize that signal output processing is in progress as well as to relax the impression of a user that a lack of image data is caused during signal output processing, similarly to the aforesaid first embodiment. Therefore, it is possible to provide a user with a digital camera exhibiting superior convenience.

Herein, in the second embodiment described above, a focus adjusting area is not necessarily included within a predetermined area of first output area R1, and may be any places in image capturing area R of image pickup device 4.

Further, this invention is not limited to the embodiments described above, and various improvements and design modifications may be performed within a range of not deviating from the objective of this invention.

For example, in the embodiments described above, the process to execute signal output processing is specified as auto focus processing, however, it is not limited thereto but may be any process being able to execute control to output effective electrical signals accumulated in first output area R1 as well as to output unnecessary electrical signals accumulated in second output areas R2 and R3 at a high speed, including such as auto white balance control processing.

What is claimed is:

1. A digital camera comprising:
an image pickup device having an image capturing area for converting optical images of a photographic object into electrical signals to accumulate;
a readout controller to control readout of the electrical signals accumulated in the image capturing area of the image pickup device;
an image information acquiring section to acquire image information according to the electrical signals being readout under the control of the readout controller;
an image display controller for controlling a display section to display images based on the image information having been acquired by the image information acquiring section; and
a signal output process executing section for executing signal output processing to output electrical signals accumulated in a first output area within the image capturing area of the image pickup device at a first speed as well as to output electrical signals accumulated in the second output area other than the first output area at a second speed higher than the first speed;
wherein the image information acquiring section acquires image information of a predetermined area according to electrical signals of the predetermined area within the first output area having been output by the signal output process executing section during the signal output processing, and
the image display controller controls to display a moving image based on the image information of the predetermined area acquired by the image information acquiring section in a display area corresponding to the predetermined area within a display area of the display section during the signal output processing, as well as displaying a predetermined still image in the display area other than the display area corresponding to the predetermined area in the display section.

2. The digital camera of claim 1, wherein the predetermined still image is a predetermined color image.

3. The digital camera of claim 1, wherein the image information acquiring section acquires whole display area image information corresponding to a whole display area of the display section based on the electrical signals being readout under the control of the readout controller at a starting timing of the signal output processing,
and the image display controller controls to display an image, as the still image on the display section during the signal output processing, based on image information in which the predetermined area image information having been acquired by the image information acquiring section is removed from the whole display area image information.

4. A digital camera comprising:
an image pickup device having an image capturing area for converting optical images of a photographic object into electrical signals to accumulate;
a readout controller to control readout of the electrical signals accumulated in the image capturing area of the image pickup device;
an image information acquiring section to acquire image information according to the electrical signals being readout under the control of the readout controller;
an image display controller for controlling a display section to display images based on the image information having been acquired by the image information acquiring section; and
a signal output process executing section for executing signal output processing to output electrical signals accumulated in a first output area within the image capturing area of the image pickup device at a first speed as well as to output electrical signals accumulated in the second output area other than the first output area at a second speed higher than the first speed;
wherein the image information acquiring section acquires a whole display area image information corresponding to the whole display area of the display section based on the electrical signals having been readout under control of the readout controller at the starting timing of the signal output processing by the signal output process executing section, and
the image display controller controls the display section to display a still image based on of the whole display area image information having been acquired by the image information acquiring section.

5. The digital camera of claim 1, further comprising an auto focus processing section for executing an auto focus processing to adjust a focus automatically at the time of image capturing of a photographic object, wherein when the auto focus processing is executed, the signal output process executing section executes the signal output processing to output the electrical signals accumulated in the first output area within the image capturing area of the image pickup device at the first speed as well as to output the electrical signals accumulated in the second output area other than the first output area at the second speed.

6. The digital camera of claim 4, further comprising an auto focus processing section for executing an auto focus processing to adjust a focus automatically at the time of image capturing of a photographic object, wherein when the auto focus processing is executed, the signal output process executing section executes the signal output processing to output the electrical signals accumulated in the first output area within the image capturing area of the image pickup device at the first speed as well as to output the electrical signals accumulated in the second output area other than the first output area at the second speed.

7. The digital camera of claim 1, further comprising an auto focus processing section for executing an auto focus processing to adjust a focus automatically at the time of image capturing of a photographic object, wherein when the auto focus processing is executed, the signal output process executing section executes the signal output processing to output the electrical signals accumulated in the first output area within the image capturing area of the image pickup device at the first speed as well as to output the electrical signals accumulated in the second output area other than the first output area at the second speed,
wherein a predetermined area within the first output area includes a focus adjusting area where a focus adjusting position of the photographic object exists.

8. The digital camera of claim 3, further comprising an auto focus processing section for executing an auto focus processing to adjust a focus automatically at the time of image capturing of a photographic object, wherein when the auto focus processing is executed, the signal output process executing section executes the signal output processing to output the electrical signals accumulated in the first output area within the image capturing area of the image pickup device at the first speed as well as to output the electrical signals accumulated in the second output area other than the first output area at the second speed,
wherein a predetermined area within the first output area includes a focus adjusting area where a focus adjusting position of the photographic object exists.

9. The digital camera of claim 4, further comprising an auto focus processing section for executing an auto focus processing to adjust a focus automatically at the time of image capturing of a photographic object, wherein when the auto focus processing is executed, the signal output process executing section executes the signal output processing to output the electrical signals accumulated in the first output area within the image capturing area of the image pickup device at the first speed as well as to output the electrical signals accumulated in the second output area other than the first output area at the second speed,
wherein a predetermined area within the first output area includes a focus adjusting area where a focus adjusting position of the photographic object exists.

10. The digital camera of claim 8, wherein the image information acquiring section acquires image information of the focus adjusting area based on the electrical signals of the focus adjusting area within the first output area having been output by the signal output process executing section during the auto focus processing, and
wherein the image display information controller controls to display an image based on image information in which the focus adjusting area image information having been acquired by the image information acquiring section is removed from the whole display area image information.

11. A method for controlling a digital camera provided with an image pickup device having an image capturing area for converting optical images of a photographic object into electrical signals to accumulate and with a display for displaying images based on image information, the method comprising:
reading out of the electrical signals accumulated in the image capturing area of the image pickup device;
acquiring image information according to the electrical signals;
displaying images based on the image information having been acquired; and
executing signal output processing to output electrical signals accumulated in a first output area within the image capturing area of the image pickup device at a first speed as well as to output electrical signals accumulated in the second output area other than the first output area at a second speed higher than the first speed;
acquiring image information of a predetermined area according to electrical signals of the predetermined area within the first output area during the signal output processing; and
displaying a moving image based on the image information of the predetermined area in a display area corresponding to the predetermined area within a display area of the display section during the signal output processing, as well as displaying a predetermined still image in the display area other than the display area corresponding to the predetermined area in the display section.

12. The method of claim 11, wherein the predetermined still image is a predetermined color image.

13. The method of claim 11, further comprising:
acquiring whole display area image information corresponding to a whole display area of the display section based on the electrical signals being readout at a starting timing of the signal output processing; and
displaying an image as the predetermined still image on the display section during the signal output processing, based on image information in which the predetermined area image information having been acquired is removed from the whole display area image information.

14. A method for controlling a digital camera provided with an image pickup device having an image capturing area for converting optical images of a photographic object into electrical signals to accumulate and with a display for displaying images based on image information, the method comprising:
reading out of the electrical signals accumulated in the image capturing area of the image pickup device;
acquiring image information according to the electrical signals being readout;
displaying images based on the image information having been acquired; and
executing signal output processing to output electrical signals accumulated in a first output area within the image capturing area of the image pickup device at a first speed as well as to output electrical signals accumulated in the second output area other than the first output area at a second speed higher than the first speed;
acquiring whole display area image information corresponding to a whole display area of the display section based on the electrical signals being readout at a starting timing of the signal output processing; and
displaying a still image based on the whole display area image information during the signal output processing.

15. The digital camera of claim 11, further comprising a step of executing an auto focus processing to adjust a focus automatically at the time of image capturing of a photographic object, wherein when the auto focus processing is executed, the signal output processing is executed to output electrical signals accumulated in a first output area within the image capturing area of the image pickup device at a first speed as well as to output electrical signals accumulated in the second output area other than the first output area at a second speed higher than the first speed.

16. The digital camera of claim 14, further comprising a step of executing an auto focus processing to adjust a focus automatically at the time of image capturing of a photographic object, wherein when the auto focus processing is executed, the signal output processing is executed to output electrical signals accumulated in a first output area within the image capturing area of the image pickup device at a first speed as well as to output electrical signals accumulated in the second output area other than the first output area at a second speed higher than the first speed.

17. The method of claim 11, further comprising a step of executing an auto focus processing to adjust a focus automatically at the time of image capturing of a photographic object, wherein when the auto focus processing is executed, the signal output processing is executed to output the electrical signals accumulated in the first output area within the image capturing area of the image pickup device at the first speed as well as to output the electrical signals accumulated in the second output area other than the first output area at the second speed,
wherein a predetermined area within the first output area includes a focus adjusting area where a focus adjusting position of the photographic object exists.

18. The method of claim 13, further comprising a step of executing an auto focus processing to adjust a focus automatically at the time of image capturing of a photographic object, wherein when the auto focus processing is executed, the signal output processing is executed to output the electrical signals accumulated in the first output area within the image capturing area of the image pickup device at the first speed as well as to output the electrical signals accumulated in the second output area other than the first output area at the second speed,
wherein a predetermined area within the first output area includes a focus adjusting area where a focus adjusting position of the photographic object exists.

19. The method of claim 14, further comprising a step of executing an auto focus processing to adjust a focus automatically at the time of image capturing of a photographic object, wherein when the auto focus processing is executed, the signal output processing is executed to output the electrical signals accumulated in the first output area within the image capturing area of the image pickup device at the first speed as well as to output the electrical signals accumulated in the second output area other than the first output area at the second speed,
wherein a predetermined area within the first output area includes a focus adjusting area where a focus adjusting position of the photographic object exists.

20. The method of claim 18, further comprising:
acquiring image information of the focus adjusting area based on the electrical signals of the focus adjusting area within the first output area during the auto focus processing, and
displaying an image based on image information in which the focus adjusting area image information is removed from the whole display area image information.
